(19) United States
(12) Patent Application Publication
(10) Pub. No.: US 2007/0055495 A1
(43) Pub. Date: Mar. 8, 2007

(54) PHRASE INPUT SYSTEM AND METHOD THEREOF

(75) Inventors: David Ho, Taipei (TW); Hua-Feng Mai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INVENTEC APPLIANCES CORP., Taipei (TW)

(21) Appl. No.: 11/469,905

(22) Filed: Sep. 5, 2006

(30) Foreign Application Priority Data
Sep. 5, 2005 (TW) 94130419

(51) Int. Cl. G06F 17/27

(52) U.S. Cl. 704/9

(57) ABSTRACT

A phrase input system and a method thereof that is applicable for a handwriting input apparatus is disclosed. The phrase input system comprises a database, an input unit, an output unit, an identification unit, and a comparison unit. The database stores a collection of phrases. The input unit is used for inputting a handwriting phrase that includes at least one handwriting character. The identification unit identifies the handwriting phrase to produce an effective phrase. The comparison unit compares the effective phrase and the collection of phrases in the database in order to find an optimum phrase. The optimum phrase is displayed through the output unit. When the phrase input system is applied to the handwriting input apparatus, the recognition rate of the handwriting is improved.

### CROSS-REFERENCE TO RELATED APPLICATION

This application claims the priority benefit of Taiwan application serial no. 94130419, filed on Sep. 5, 2005. All disclosure of the Taiwan application is incorporated herein by reference.

### BACKGROUND OF THE INVENTION

1. Field of the Invention

The present invention relates to a phrase input system and method thereof, and more particularly, to a handwriting input apparatus that uses the phrase input system and method to improve the recognition rate of handwriting.

2. Description of Related Art

FIG. 1 is a block diagram of a conventional input system. As shown in FIG. 1, an input system 12 is applied to a handwriting input apparatus 11. The handwriting input apparatus 11 is a mobile phone. The input system 12 includes an output/input unit 13, a processing unit 14 and a database 15. When the mobile phone user inputs a handwriting character through the output/input unit 13, the handwriting character is identified by an identification module 141 in the processing unit 14 to produce an effective character. The effective character is transmitted to a search engine 142. The search engine 142 searches for a number of proximate characters from a character collection 151 in the database 15 according to the effective character. Thereafter, the proximate characters are transmitted to a register 143. The processing unit 14 transmits the proximate characters in the register 143 to the output/input unit 13. The output/input unit 13 displays the proximate characters so that the mobile phone user can select the required character.

FIG. 2 is a flow chart showing a conventional handwriting input method. First the mobile phone is turned on (S21). Then, the mobile phone user inputs a handwriting character (S22). The identification module identifies the handwriting character and produces an effective character (S23). According to the effective character, the search engine searches a database for proximate characters (S24). The proximate characters are transmitted to a register (S25). Afterwards, a processing unit transmits the proximate characters in the register to an output/input unit (S26). Then, the output/input unit displays the proximate characters on the mobile phone for the user to choose and confirm (S27). The proximate characters on display are checked to see if the required character is included in the proximate characters (S28). If it is, then the process ends. Otherwise, the process is returned to the former state (S22).

As the popularity of handwriting input apparatus increases, handwriting identification is one of the most personalized input methods and is widely adopted to be the input system of mobile phones. However, due to the intrinsic limitation of the handwriting identification, the problems of most input methods involving handwriting identification currently in the market include slow input speed and low recognition rate. One of the principle reasons for this to occur is that the handwriting identification process is still performed one handwriting character at a time. Therefore, when the input system is applied to a mobile phone, it is not possible to identify a multiple of handwriting characters at the same time. Moreover, a database with a collection of commonly used phrases is absent. Hence, the goal of the present invention is to develop a phrase input system and method thereof.

### SUMMARY OF THE INVENTION

The present invention provides a phrase input system suitable for a handwriting input apparatus. The phrase input system includes at least a database, an input unit, an output unit, an identification unit and a comparison unit. The database stores a collection of phrases. The input unit is used for inputting a handwriting phrase. The handwriting phrase includes at least a handwriting character. The identification unit identifies the handwriting phrase to produce an effective phrase. The comparison unit compares the effective phrase and the collection of phrases in the database in order to find an optimum phrase in the database corresponding to the effective phrase. The optimum phrase is displayed through the output unit.

The present invention also discloses a phrase input method applicable for a handwriting input apparatus. The method includes the following steps. First, a collection of phrases is stored. Then, a first handwriting phrase is inputted. The first handwriting phrase includes at least a handwriting character. The first handwriting phrase is identified to produce a first effective phrase comprising the character. The first effective phrase is compared with the collection of phases in order to find an optimum phrase corresponding to the first effective phrase. Then the optimum phrase is displayed.

The present invention also discloses a phrase input method that further includes a checking and adding procedure as follows. According to the comparison of the first effective phrase and the collection of phrases, if the optimum phrase is not found, a warning signal indicating the optimum phrase is not found is issued. The warning signal also inquires the user whether the user wants to establish a new phrase as the optimum phrase corresponding to the first effective phrase. If the answer is ‘no’, the checking and adding procedure ends. If the answer is ‘yes’, a character of the first effective phrase from a database is used to form the new phrase. Then the new phrase is added to the collection of phrases and the checking and adding procedure ends.

The present invention also discloses a phrase input method that further includes an automatic phrase establishing procedure. The automatic phrase establishing procedure includes at least the following steps. If the optimum phrase is not found by the comparison step, using the character of the first effective phrase from a database to form a new phrase as the optimum phrase corresponding to the first effective phrase, and adding the new phrase to the collection of phrases.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional input system.

FIG. 2 is a flow chart showing a conventional input method.

FIG. 3 is a block diagram of a phrase input system according to the present invention.

FIG. 4 is a diagram showing one application of the phrase input system according to the present invention.

FIG. 5 is a flow chart of a phrase input method according to the present invention.

FIG. 6 is a flow chart of a checking and adding procedure according to the present invention.

FIG. 7 is a flow diagram of an automatic phrase establishing procedure according to the present invention.

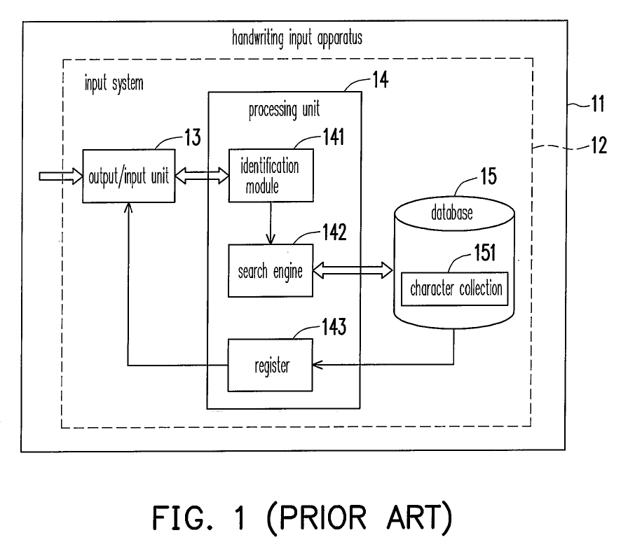

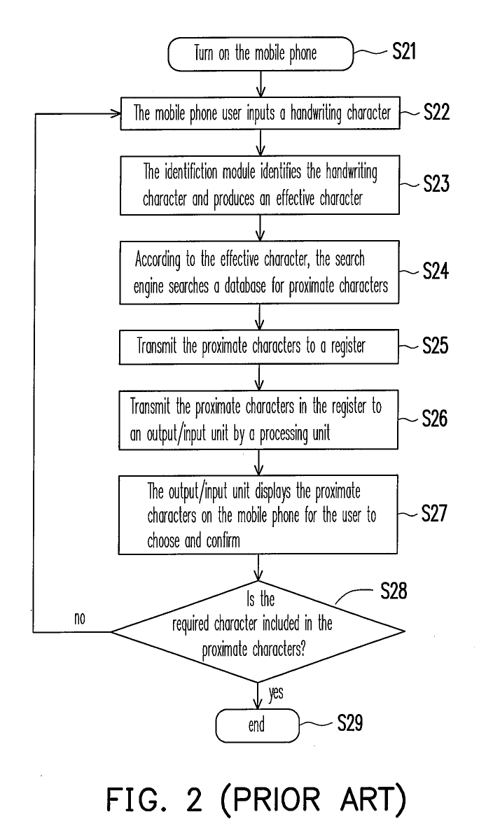

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

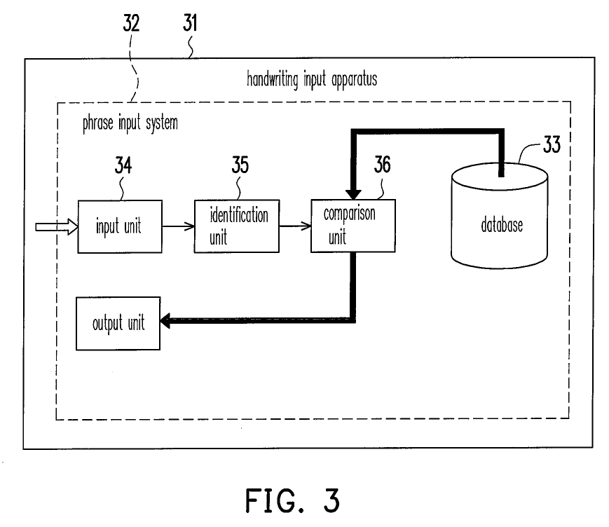

FIG. 3 is a block diagram of a phrase input system according to the present invention. As shown in FIG. 3, a phrase input system 32 is applied to a handwriting input apparatus 31. The handwriting input apparatus 31 is a mobile phone. The phrase input system 32 includes a database 33, an input unit 34, an identification unit 35, a comparison unit 36 and an output unit 37. The database 33 stores a collection of phrases which are commonly used. The input unit 34 is used for inputting a handwriting phrase. The handwriting phrase includes at least a handwriting character. Furthermore, the output unit 37 includes a liquid crystal display. The identification unit 35 identifies the handwriting phrase to produce an effective phrase. The comparison unit 36 compares the effective phrase and the collection of phrases in the database in order to find an optimum phrase in the database corresponding to the effective phrase. The optimum phrase is displayed on the liquid crystal display.

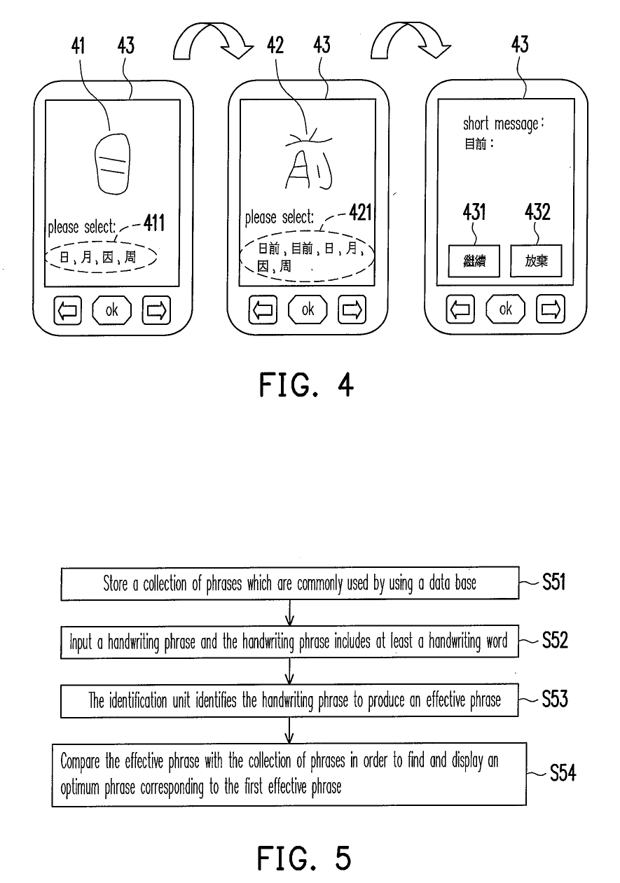

FIG. 4 is a diagram showing one application of the phrase input system according to the present invention. As shown in FIG. 4, a phrase input system is implemented on a mobile phone. A handwriting character [symbol] 41 is inputted on the liquid crystal display 43 on the mobile phone. After that, an optimum group of characters 411 is produced for the mobile phone user to choose. If the mobile phone user continues to input the next handwriting character [symbol] 42, another optimum group of characters 421 is produced for the mobile phone user to choose. When the mobile phone user chooses the required phrase [symbol] , the two characters [symbol] appear on the liquid crystal display 43. The mobile phone user can choose whether to continue 431 inputting the next handwriting character or quit 432 the handwriting action.

FIG. 5 is a flow chart of a phrase input method according to the present invention. As shown in FIG. 5, a database is used for storing a collection of phrases which are commonly used (S51). A handwriting phrase is inputted and the handwriting phrase includes at least a handwriting character (S52). The identification unit identifies the handwriting phrase to produce an effective phrase (S53). The effective phrase is compared with the collection of phrases in order to find and display an optimum phrase corresponding to the first effective phrase (S54). Through the foregoing flow, phrase input is achieved.

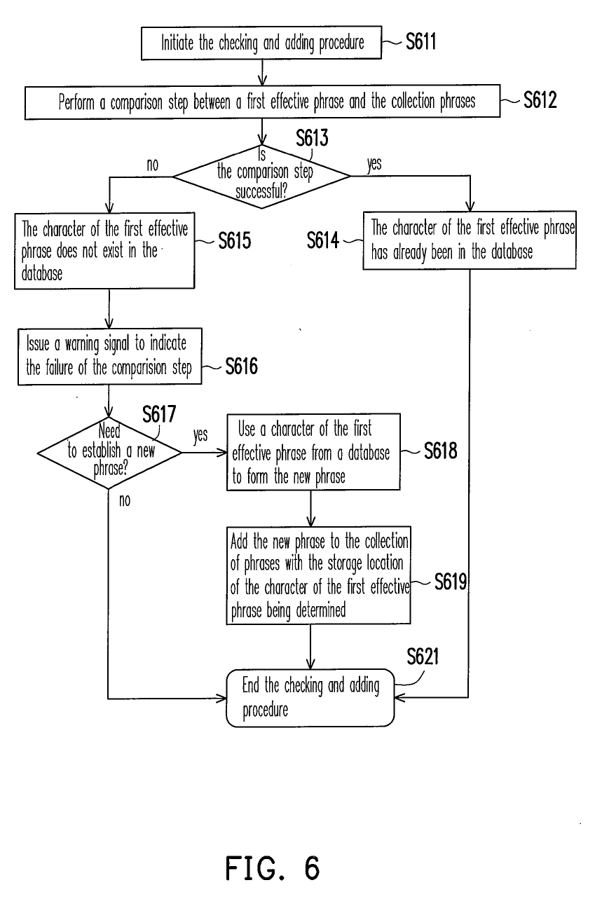

FIG. 6 is a flow chart of a checking and adding procedure according to the present invention. First, the checking and adding procedure is initiated (S611). Then, a comparison step is performed between a first effective phrase and the collection of phrases (S612). The comparison step is determined if it is successful (S613). If the comparison step is successful, it means that the character of the first effective phrase has already been in the database (S614). Thereafter, the checking and adding procedure ends (S621). If the comparison step fails, it means that the character of the first effective phrase does not exist in the database (S615). Then, a warning signal is issued to indicate the failure of the comparison step (S616). The user is also inquired to determine whether to establish a new phrase (S617). If the answer is a ‘no’, the checking and adding procedure ends (S621). Conversely, if the answer is a ‘yes’, a character of the first effective phrase from a database is used to form the new phrase (S618). Then the new phrase is added to the collection of phrases with the storage location of the character of the first effective phrase being determined (S619). Then, the checking and adding procedure ends (S621). Through the foregoing flow, phrase checking and the adding of new phrases are achieved.

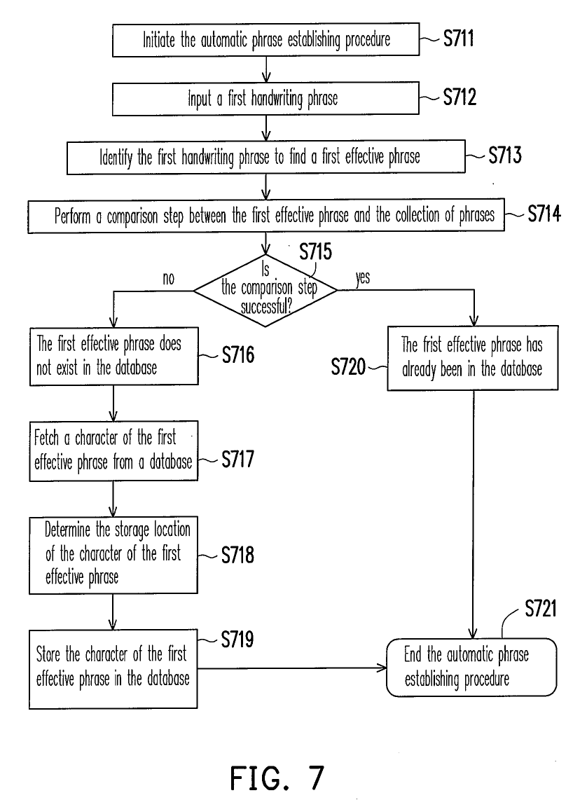

FIG. 7 is a flow chart of an automatic phrase establishing procedure according to the present invention. First, the automatic phrase establishing procedure is initiated (S711). Then, a first handwriting phrase is inputted (S712). The first handwriting phrase is identified to find a first effective phrase (S713). A comparison step is performed between the first effective phrase and the collection of phrases (S714). Thereafter, the comparison step is determined if it is successful (S715). If the comparison step is successful, it means that the first effective phrase has already been in the database (S720). Then, the automatic phrase establishing procedure ends (S721). Conversely, if the comparison step fails, it means that the first effective phrase does not exist in the database (S716). A character of the first effective phrase is fetched from a database (S717). The storage location of the character of the first effective phrase is determined (S718). The character of the first effective phrase is stored in the database (S719). After that, the automatic phrase establishing procedure ends (S721). Through the foregoing flow, the automatic phrase establishing is achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A phrase input system for a handwriting input apparatus, the system comprising:
a database for storing a collection of phrases;
an input unit for inputting a handwriting phrase, wherein the handwriting phrase comprises a handwriting character;
an identification unit for identifying the handwriting phrase to produce an effective phrase;
a comparison unit for comparing the effective phrase and the collection of phrases in the database to find an optimum phrase in the database corresponding to the effective phrase; and
an output unit for outputting the optimum phrase for displaying the optimum phrase.

2. The phrase input system of claim 1, wherein the handwriting input apparatus is a mobile phone.

3. The phrase input system of claim 1, wherein the phrase database stores a collection of commonly used phrases.

4. The phrase input system of claim 1, wherein the output unit comprises a liquid crystal display.

5. A method of inputting a phrase, applicable for a handwriting input apparatus, the method comprising:
storing a collection of phrases;
inputting a first handwriting phrase, wherein the first handwriting phrase comprises a handwriting character;
identifying the first handwriting phrase to produce a first effective phrase comprising the character; and
comparing the first effective phrase and the collection of phrases to find and then display an optimum phrase corresponding to the first effective phrase.

6. The method of claim 5, further comprising a checking and adding procedure, the procedure comprising the following steps:
if the optimum phrase is not found by the comparison step, issuing a warning signal;
asking whether to establish a new phrase as the optimum phrase corresponding to the first effective phrase; and
if an answer to the asking step is yes, using the character of the first effective phrase from a database to form the new phrase, and adding the new phrase to the collection of phrases.

7. The method of claim 5, further comprising an automatic phrase establishing procedure comprising the following steps:
if the optimum phrase is not found by the comparison step, using the character of the first effective phrase from a database to form a new phrase as the optimum phrase corresponding to the first effective phrase, and adding the new phrase to the collection of phrases.
